(19) United States
(12) Patent Application Publication
(10) Pub. No.: US 2022/0277278 A1
(43) Pub. Date: Sep. 1, 2022

(54) PERSONALIZED DOCUMENT PROCESSING SYSTEM WITH SUBSCRIPTION BASED FUNCTIONALITY

(71) Applicant: Entrust Corporation, Shakopee, MN (US)

(72) Inventors: Daniel Lee Good, Lakeville, MN (US); Uwe Gerd Jaspers, Juechen (DE)

(21) Appl. No.: 17/684,087

(22) Filed: Mar. 1, 2022

Related U.S. Application Data
(60) Provisional application No. 63/154,978, filed on Mar. 1, 2021.

(51) Int. Cl. G06Q 20/12

(52) U.S. Cl. CPC G06Q 20/127

(57) ABSTRACT

A method of operating a personalized document processing system that is configured to process a plurality of personalized documents under a subscription plan is provided. The method includes a controller of the personalized document processing system receiving a subscription plan key code. The method also includes the controller verifying the subscription plan key code. Also, the method includes determining and setting a subscription threshold for a processing module of the personalized document processing system based on the subscription plan key code. The processing module is configured to perform a processing operation on one or more of the plurality of personalized documents. Further, the method includes tracking operation of the processing module to determine whether the subscription threshold has been reached. Moreover, the method includes adjusting operation of the processing module when the subscription threshold has been reached.

### FIELD

This disclosure relates to personalized document processing systems that process personalized documents including, but not limited to, plastic cards (e.g., financial (e.g., credit, debit, or the like) cards, driver's licenses, national identification cards, business identification cards, gift cards, and other plastic cards), passports, etc. In particular, this disclosure relates to personalized document processing systems with subscription based functionality.

### BACKGROUND

Technological improvements in personalized document processing systems, such as drop-on-demand printing, can result in increased costs to manufacture these systems. This can lead to increased costs to customers who wish to utilize these technological improvements. Also, while customers may want to take advantage of some of the technological improvements provided in a personalized document processing system, these customers may not want to pay all of the additional feature sets provided by the technological improvements.

### SUMMARY

Systems and methods are described where a personalized document processing system includes subscription based functionality. The personalized document processing system can include a plurality of modules for processing a personalized document. One or more modules of the personalized document processing system can be controlled via a subscription plan.

In some embodiments, the methods and systems described herein can control output capacity of one or more modules of the personalized document processing system over a set period of time as determined by a subscription plan. For example, the subscription plan can set a capacity threshold for one or more modules of the personalized document processing system. If an end user wishes to print more personalized documents than allowed by the capacity threshold, the end user can purchase an upgraded subscription plan that allows the end user to print additional personalized documents.

In some embodiments, the methods and systems described herein can control feature functionality of one or more modules of the personalized document processing system over a set period of time as determined by a subscription plan. For example, the subscription plan can set a functionality threshold for one or more modules of the personalized document processing system. The functionality threshold can designate certain feature sets (e.g., color printing, black and white printing, base dots per inch (DPI) level, security features formed by a laser, laser functionality, duplex printing, etc.) available to one or more modules of the personalized document processing system. If an end user wishes to add additional feature sets or reduce feature sets currently provided by the functionality threshold, the end user can purchase a new subscription plan that provides the desired feature sets.

Accordingly, the embodiments described herein can allow an end user to apply different subscription plans to a personalized document processing system based on the needs of the end user. The end user can modify the subscription plan as needed to increase or reduce output capacity and/or functionality of the one or more modules of the personalized document processing system.

The personalized documents to be processed as described herein include, but are not limited to, plastic cards which bear personalized data unique to the intended cardholder and/or which bear other card information. Examples of plastic cards can include, but are not limited to, financial (e.g., credit, debit, or the like) cards, driver's licenses, national identification cards, business identification cards, gift cards, and other plastic cards. The personalized documents to be processed can also include, for example, passports.

The drop-on-demand personalized document printing module, as described herein, can print using any suitable ink used in drop-on-demand printing and that is suitable for use on the types of personalized documents described herein. For example, the ink can be an ultraviolet (UV) curable ink. The drop-on-demand personalized document printing module can have a single print head or a plurality of print heads. The drop-on-demand personalized document printing module can perform monochromatic or multi-color printing. In one example of multi-color printing, five print heads, each of which has a nozzle plate, can be provided. Each print head can be designated to print a specific color ink, such as cyan, magenta, yellow, black and white (CMYKW).

The personalized document processing system described herein can be any personalized document processing system that can process personalized documents such as by printing on the personalized documents using the drop-on-demand personalized document printing module, in combination with one or more of: reading data from and/or writing data to a magnetic stripe on the personalized documents, programming an integrated circuit chip on the personalized documents, emboss characters on the personalized documents, indenting characters on the personalized documents, laminating the personalized documents, using a laser that performs laser processing such as laser marking on the personalized documents, applying a topcoat to a portion of or the entire surface of the personalized documents, checking the quality of personalization/processing applied to the personalized documents, applying a security feature such as a holographic foil patch to the personalized documents, and other personalized document processing operations. In some embodiments, the personalized document processing system can be a central issuance personalized document processing system. In some embodiments, the personalized document processing system can be a desktop personalized document processing system. It will be appreciated that the personalized documents processed by the personalized document processing system can be, for example, plastic cards, passports, etc.

In one embodiment, a method of operating a personalized document processing system that is configured to process a plurality of personalized documents under a subscription plan is provided. The method includes a controller of the personalized document processing system receiving a subscription plan key code. The method also includes the controller verifying the subscription plan key code. Also, the method includes determining and setting a subscription threshold for a processing module of the personalized document processing system based on the subscription plan key code. The processing module is configured to perform a processing operation on one or more of the plurality of personalized documents. Further, the method includes tracking operation of the processing module to determine whether the subscription threshold has been reached. Moreover, the method includes adjusting operation of the processing module when the subscription threshold has been reached.

In another embodiment, a personalized document processing system for processing a plurality of personalized documents is provided. The personalized document processing system includes a processing module and a controller. The processing module is configured to perform a processing operation on one or more of the plurality of personalized documents. The controller is configured to control operation of the processing module. Also, the controller is configured to: receive a subscription plan key code; verify the subscription plan key code; determine and set a subscription threshold for the processing module based on the subscription plan key code; track operation of the processing module to determine whether the subscription threshold has been reached; and adjust operation of the processing module when the subscription threshold has been reached.

In yet another embodiment, a method of updating a subscription plan on a secured personalized document processing system is provided. The method includes loading a subscription plan key code onto a memory device that is separate from the secured personalized document processing system. Also, the method includes physically connecting the memory device to the secured personalized document processing system. The method further includes transferring the subscription plan key code from the memory device to a controller of the secured personalized document processing system. Moreover, the method includes the controller receiving the subscription plan key code. The method also includes the controller adjusting operation of a processing module of the secured personalized document processing system based on the subscription plan key code.

In another embodiment, a method of updating a subscription plan on a secured personalized document processing system is provided. The method includes receiving a manual entry of a subscription plan key code via a human machine interface of the secured personalized document processing system. The method also includes transferring the subscription key code in a controller of the secured personalized document processing system. Also, the method includes the controller receiving the subscription plan key code. Further, the method includes the controller adjusting operation of a processing module of the secured personalized document processing system based on the subscription plan key code.

### DRAWINGS

FIG. 1 illustrates a personalized document processing system, according to one embodiment.

FIG. 2 illustrates select components of a drop-on-demand personalized document printing module of the personalized document processing system of FIG. 1.

FIG. 3 illustrates a method of operating the system under a subscription plan, according to one embodiment.

### DETAILED DESCRIPTION

Systems and methods are described where a personalized document processing system includes subscription based functionality. The personalized document processing system can include a plurality of modules for processing a personalized document. One or more modules of the personalized document processing system can be controlled via a subscription plan.

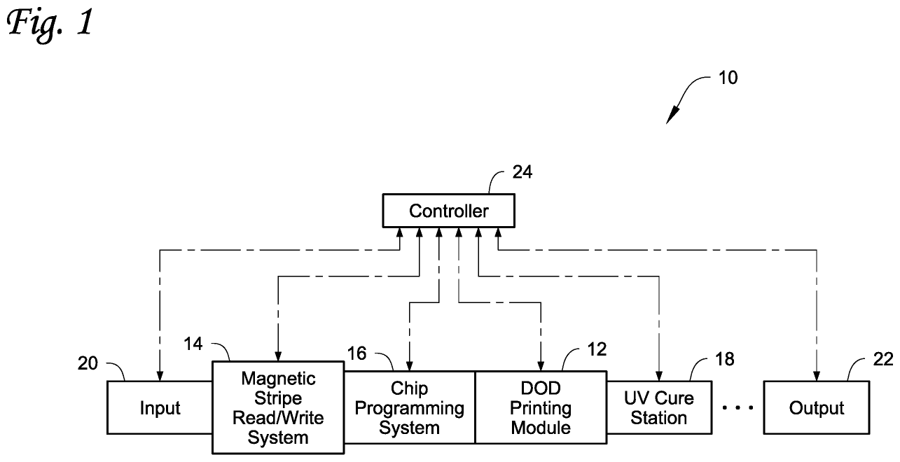

FIG. 1 illustrates an example of a personalized document processing system 10 described herein. The system 10 is configured to process personalized documents by at least printing on the personalized documents using a drop-on-demand (DOD) personalized document printing module 12 included in the system 10. The system 10 can also include at least one other personalized document processing operation or capability in addition to the printing by the DOD personalized document printing module 12. For example, the additional personalized document processing can include a magnetic stripe read/write module 14 that is configured to read data from and/or write data to a magnetic stripe on the personalized documents, and/or an integrated circuit chip programming module 16 that is configured to program an integrated circuit chip on the personalized documents. DOD printing systems are disclosed in, for example, U.S. Pat. Nos. 7,344,231, 8,702,893, 10,049,320, 10,160,247, 10,576,769, 10,507,677, 10,603,917, 10,899,129, 10,899,135, U.S. Patent Publication No. 2017/0228632, U.S. Patent Publication No. 2018/0326761, U.S. Patent Publication No. 2019/0134986, U.S. Patent Publication No. 2019/0344565, U.S. Patent Publication No. 2020/00238746, U.S. Patent Publication No. 2020/0039228, U.S. Patent Publication No. 2020/0307265, all of which are incorporated herein by reference in their entirety.

When the DOD personalized document printing module 12 prints using ultraviolet (UV) curable ink, a UV cure station 18 can also be provided. The construction and operation of the modules 14, 16, 18 is well known in the art. Magnetic stripe read/write systems and integrated circuit chip programming systems are disclosed, for example, in U.S. Pat. Nos. 6,902,107 and 6,695,205, and can be found in the MX family of central issuance systems available from Entrust Corporation of Shakopee, Minn. An example of a UV radiation applicator in a personalized document printing system is the Persomaster card personalization system available from Atlantic Zeiser GmbH of Emmingen, Germany.

The personalized documents to be processed as described herein include, but are not limited to, plastic cards, passports, etc. which bear personalized data unique to the intended personalized document holder and/or which bear other personalized document information. Examples of plastic cards can include, but are not limited to, financial (e.g., credit, debit, or the like) cards, driver's licenses, national identification cards, business identification cards, gift cards, and other plastic cards.

In the system 10 illustrated in FIG. 1, a personalized document input 20 is provided that is configured to hold a plurality of personalized documents waiting to be processed. Personalized documents are fed one-by-one from the personalized document input 20 into the rest of the system 10 where each personalized document is individually processed. Processed personalized documents are transported into a personalized document output 22 that is configured to hold a plurality of the processed personalized documents. A controller 24 manages and controls operation of the system 10.

The personalized document processing system 10 illustrated in FIG. 1 is a type of system that can be referred to as a central issuance personalized document processing system. In a central issuance personalized document processing system, the personalized document input 20 and the personalized document output 22 are generally at opposite ends of the system with the personalized document processing mechanisms, such as the modules 12, 14, 16, 18 in FIG. 1, between the personalized document input 20 and the personalized document output 22. A central issuance personalized document processing system is typically designed for large volume batch processing of personalized documents, often employing multiple processing stations or modules to process multiple personalized documents at the same time to reduce the overall per personalized document processing time. Examples of central issuance personalized document processing systems include the MX family of central issuance systems available from Entrust Corporation of Shakopee, Minn. Other examples of central issuance systems are disclosed in U.S. Pat. Nos. 4,825,054, 5,266,781, 6,783,067, and 6,902,107, all of which are incorporated herein by reference in their entirety. In one example, the personalized document processing system 10 can process personalized documents at a rate of at least about 500 personalized documents per hour, or at least about 1000 personalized documents per hour, or at least about 1500 personalized documents per hour, or at least about 2000 personalized documents per hour, or at least about 2500 personalized documents per hour.

In FIG. 1, the modules 12, 14, 16, 18 are downstream of the personalized document input 20 and between the personalized document input 20 and the personalized document output 22. The sequence or arrangement of the modules 12, 14, 16, 18 relative to one another and relative to the personalized document input 20 can be varied from the sequence that is illustrated in FIG. 1. Each of the modules 12, 14, 16, 18 includes a processor and a memory so as to communicate with the controller 24. Also, each of the modules 12, 14, 16, 18 is configured to perform a processing operation on a personalized document as it passes through the particular module 12, 14, 16, 18. It will also be appreciated that different types of personalized documents being processed through the system 10 may require only some and not all of the processing operations performed by the modules 12, 14, 16, 18. In these instances, one or more of the modules 12, 14, 16, 18 may not perform a processing operation on the personalized document as it passes there through on its path from the personalized document input 20 to the personalized document output 22.

The system 10 may include additional personalized document processing modules not illustrated in FIG. 1, which are well known in the art of personalized document processing and which may also be located between the personalized document input 20 and the personalized document output 22. For example, the system 10 may include a personalized document embossing module that is configured to emboss characters on the personalized documents; an indenting system that is configured to indent characters on the personalized documents; a laminator module that is configured to apply a laminate to the personalized documents; a laser module that uses a laser to perform laser processing such as laser marking on the personalized documents; a topcoat module that is configured to apply a topcoat to a portion of or the entire surface of the personalized documents; a quality control module that is configured to check the quality of personalization/processing applied to the personalized documents; a security module that is configured to apply a security feature such as a holographic foil patch to the personalized documents; and other personalized document processing operations. The additional personalized document processing modules may be located anywhere in the system 10, such as between the UV cure station 18 and the personalized document output 22.

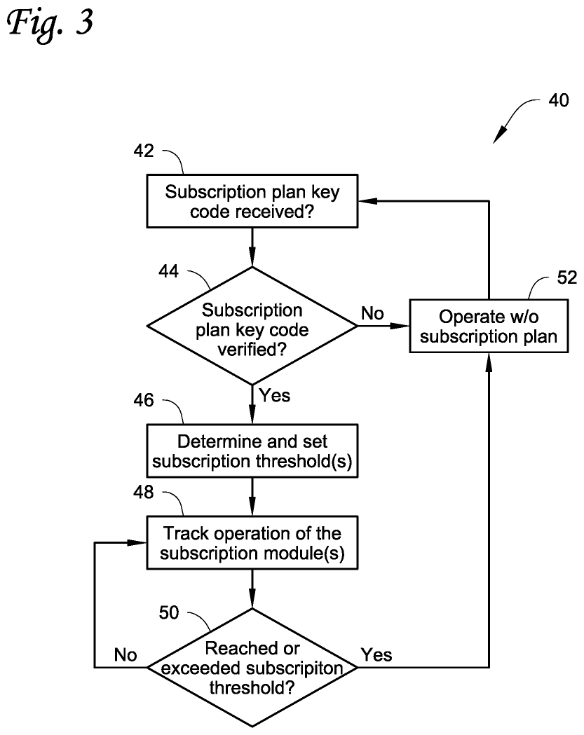

The controller 24 includes a processor (not shown) and a memory (not shown) and is configured to control operation of the system 10 including each of the modules 12, 14, 16 and 18. In order to control operation of the system 10, the controller 24 is configured to communicate with each of the modules 12, 14, 16 and 18, the personalized document input 20, and the personalized document output 22 via, for example, a communication bus (not shown). In some embodiments, the communication bus can be through an Ethernet connection using a TCP/IP protocol. In some embodiments, the controller 24 can include one or more hardware security modules (HSMs) that can be used to store one or more private or public keys. A HSM, as defined herein, refers to a physical computing device that safeguards and manages cryptographic objects for storing authentication and providing crypto-processing. In some embodiments, the controller 24 can operate the system 10 to operate under a subscription plan or without a subscription plan. A method of operating the system 10 under a subscription plan is discussed below with respect to FIG. 3.

In some embodiments, the system 10 may be required to meet stringent security standards (such as, for example, when being operated by a bank or financial bureau) that limit or precludes any communication with another entity that is not part of the system 10. For example, when the system 10 is processing personalized documents for a bank or financial bureau, the system 10 may be precluded from communicating with any other entity except for a specified server/computer(s) that is providing account holder information to be processed into the personalized documents passing through the system 10. In these embodiments, it will be appreciated that firmware and/or software updates can only be uploaded into the controller 24 and/or the modules 12, 14, 16, 18 via a physical connection (e.g., a USB port, etc.) by a service technician. Also, control and communication with the system 10 can be limited via the physical connection and/or a human machine interface (HMI) (not shown) of the system 10 that is coupled to the controller 24.

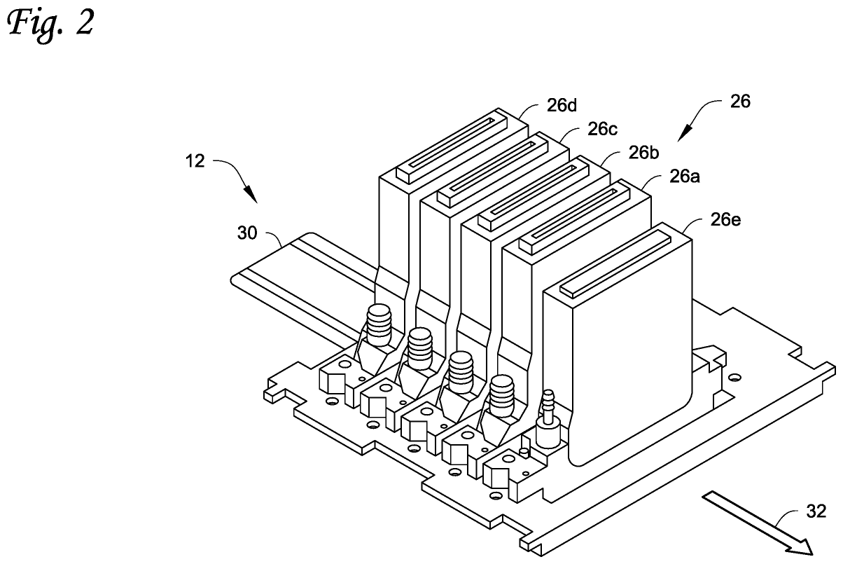

FIG. 2 illustrates select components of the drop-on-demand personalized document printing module 12. In one embodiment, the module 12 includes at least one DOD print head 26 and an automated cleaning mechanism 28 that is configured to clean a nozzle plate of the DOD print head 26. The printing performed by the drop-on-demand personalized document printing module 12 can be monochromatic or multi-color. FIG. 2 shows five DOD print heads 26a-e arranged side-by-side to sequentially print onto a surface of a personalized document 30 as the personalized document 30 is transported past the print heads 26a-e, for example underneath the print heads 26a-e, in the direction of the arrow 32. However, a smaller number of the DOD print heads, including one of the DOD print heads, or a larger number of the DOD print heads, can be used.

The DOD print heads 26a-e can print using any suitable ink or coating used in drop-on-demand printing and that is suitable for use on the types of personalized documents described herein. For example, the ink can be a UV curable ink, a heat curable ink that can be cured by applying heat to the heat curable ink, or other ink or materials that can be deposited by DOD print heads. In the case of the five DOD print heads 26a-e, each DOD print head can print a specific color ink. For example, the DOD print head 26d can print cyan colored ink, the DOD print head 26c can print magenta colored ink, the DOD print head 26b can print yellow colored ink, the DOD print head 26a can print black ink, and the DOD print head 26e can print white ink. An example of a drop-on-demand printer that prints using UV curable ink in a personalized document printing system is the Persomaster card personalization system available from Atlantic Zeiser GmbH of Emmingen, Germany.

FIG. 3 illustrates a method 40 of operating the system 10 under a subscription plan, according to one embodiment. The method 40 begins at 42 whereby the controller 24 waits until a subscription plan key code is received. In some embodiments, when the system 10 is operating under stringent security requirements that, for example, limit or precludes any communication with another entity that is not part of the system 10, the controller 24 can receive a subscription plan key code via a physical connection (e.g., a USB port, manual entry through the HMI). For example, the subscription plan key code can be loaded into a memory device (e.g., a flash memory drive, etc.) that is separate from the secured system 10. The memory device can then be physically connected to the system 10 (e.g., via a USB port on the HMI). The subscription plan key code loaded on the memory device can then be transferred, via the physical connection, to the controller 24 to allow the controller 24 to receive the subscription plan key code. In some embodiments, the controller 24 can receive a subscription plan key code via a wireless connection (e.g., via an internet connection) to an outside entity. In these embodiments, a secure communication link can be established between the system 10 and a server operated by the manufacture of the system 10. In some embodiments, the secure communication link can include mutual authentication between the system 10 and the server. It will be appreciated that in some embodiments the subscription plan key code can be encrypted and/or contained in a signed certificate. Once a subscription plan key code is received, the method 40 proceeds to 44.

At 44, the controller 24 verifies that the subscription plan key code is a proper key code for the system 10. In some embodiments, the subscription plan key code can be unique to the particular system 10. That is, the subscription plan key code that is verified for the system 10 may not be successfully verified for any other personalized document processing system. For example, the subscription plan key code can include a system identifier that ties the subscription plan key code to the particular system 10. In some embodiments, the subscription plan key code can be a string of alphanumeric digits. In some embodiments, the subscription plan key code can be encrypted. In some embodiments, the subscription plan key code can be included in a certificate that is digitally signed. In these embodiments, the controller 24 can also authenticate and decrypt the subscription plan key code (as part of the verification) by using, for example, a public or private key stored in an HSM of the controller 24.

If the controller 24 verifies that the subscription plan key code is a proper key code, the method proceeds to 46. If the controller 24 determines that the subscription plan key code is not a proper key code, the method proceeds to 52.

At 46, the controller 24 determines and sets a subscription threshold(s) to one or more of the modules 12, 14, 16, 18 based on the subscription plan key codes. The one or more modules 12, 14, 16, 18 that are operating with a subscription threshold(s) are herein referred to as the one or more subscription modules. In some embodiments, the subscription plan key code can indicate the type of subscription plan being applied to the system 10. In some embodiments, the subscription threshold(s) can include one or more capacity threshold(s) and/or one or more functionality threshold(s). A capacity threshold can indicate the number of personalized documents that can undergo a processing operation by the one or more subscription modules over a set period of time (e.g., a year). For example, in one embodiment, the capacity threshold can be an annual capacity threshold that limits the number of personalized documents that can undergo a DOD printing operation from the DOD personalized document printing module 12 over the course of a year. A functionality threshold can designate which features of the one or more subscription modules are available over a set period of time (e.g., a year). For example, in one embodiment, the functionality threshold can designate the functionality of the DOD personalized document printing module 12 to print in both color and black and white. In another example, the functionality threshold can designate the functionality of the DOD personalized document printing module 12 to improve the quality of the printing operation from a baseline DPI (e.g., 100 DPI) to an improved DPI (e.g., 300 DPI). While the examples provided herein are directed to the DOD personalized document printing module 12, it will be appreciated that the subscription threshold(s) can be for any of the modules 12, 14, 16, 18 or any other additional personalized document processing modules provided in the system 10. For example, in some embodiments, the functionality threshold can designate the functionality of the laser module to apply a laser feature (for example, a security feature) to the personalized document.

In some embodiments, the subscription plan key code can include an expiration date and/or set time period tied to the subscription plan being applied to the system 10. After the expiration date and/or the set time period has lapsed, the controller 24 can operate the system 10 without a subscription plan, as discussed in further detail below. In some embodiments, the subscription plan key code does not have an expiration date tied to the subscription plan being applied to the system 10 to allow the system 10 to stay at the certain subscription plan until a new subscription plan key code is entered that upgrades, downgrades, cancels, or otherwise changes the subscription plan currently associated with the system 10.

Once the controller 24 determines the subscription threshold(s) to be applied to the system 10, the controller 24 can store the subscription threshold(s) in the memory of the controller 24 to allow the controller 24 to instruct the one or more subscription modules based on the subscription threshold(s). The method 40 proceeds to 48.

At 48, the controller 24 tracks operation of the system 10 and in particular the one or more subscription modules that are operating under the subscription threshold(s). In some embodiments, when the subscription threshold(s) includes a capacity threshold, the controller 24 can track the number of personalized documents undergoing a processing operation by the one or more subscription modules. For example, when the subscription threshold(s) includes a capacity threshold for the DOD personalized document printing module 12, the controller 24 can track the number of personalized documents that the DOD personalized document printing module 12 has performed a printing operation thereon.

In some embodiments, when the subscription threshold(s) includes a capacity threshold, the controller 24 can track a trajectory of the number of personalized documents undergoing a processing operation by the one or more subscription modules over a set period of time. For example, when the subscription threshold(s) includes a capacity threshold for the DOD personalized document printing module 12, the controller 24 can track, based on the trajectory of use, whether the number of printing operations performed by the DOD personalized document printing module 12 is likely to exceed the capacity threshold before the set time period has ended.

In some embodiments, the controller 24 can send a warning or alert notifying a user that the system 10 is approaching the capacity threshold, that the rate at which the subscription module(s) are performing processing operations indicates that the capacity threshold will be exceeded before the set time period is reached, and/or that the expiration date or set time period is approaching. The warning or alert can encourage the user to request a new subscription plan to avoid interruption of service of the one or more subscription modules. In some embodiments, the controller 24 can send a warning or alert to the user via the HMI of the system 10. In some embodiments, the controller 24 can send a warning or alert to the user via a wireless connection (e.g., via an internet connection) to an outside entity.

In some embodiments, when the subscription threshold(s) includes a functionality threshold, the controller 24 can control which feature sets of the one or more subscription modules can be used for performing a processing operation on personalized documents passing through the system 10. For example, when the subscription threshold(s) includes a functionality threshold for the DOD personalized document printing module 12 to allow printing only in black and white and not in color, the controller 24 can instruct the DOD personalized document printing module 12 to perform only black and white printing operations on personalized documents passing there through. In another example, when the functionality threshold for the DOD personalized document printing module is to allow printing at or below 300 DPI, the controller 24 can instruct the DOD personalized document printing module 12 to perform printing operations at 300 DPI or below on personalized documents passing there through.

The method 40 then proceeds to 50.

At 50, the controller 24 determines whether the one or more subscription modules has reached or exceeds the subscription threshold(s). If the controller 24 determines that any of the one or more subscription modules has reached the subscription threshold(s), the method proceeds to 52. If the controller 24 determines that none of the one or more subscription modules has reached the subscription threshold(s), the method returns to 48.

At 52, the controller 24 continues operation of the system 10 without a subscription plan. In some embodiments, the controller 24 can control operation of the system 10 without a subscription plan by stopping operation of the one or more subscription modules. In these embodiments, the system 10 can still process personalized document(s) but the controller 24 controls the one or more subscription modules such that any personalized document being processed by the system 10 passes through the one or more subscription modules without the one or more subscription modules performing a processing operation on the personalized document(s). In some embodiments, the controller 24 can control operation of the system 10 without a subscription plan by limiting functionality of the one or more subscription modules. For example, if the one or more subscription modules is the DOD personalized document printing module 12, the controller 24 can limit the functionality by, for example, allowing the DOD personalized document printing module 12 to only print in black and white and not in color, reducing quality of the printing operation (e.g., reducing a DPI of the DOD personalized document printing module 12, etc.), etc.

In some embodiments, the controller 24 can also send a warning or alert notifying a user that no further personalized documents can be processed using the one or more modules 12, 14, 16, 18 until a subscription time period is reached and/or a new subscription plan key code is received by the controller 24. The warning or alert can notify the user that the subscription threshold(s) has been met or exceeded and/or that the time period of the subscription has lapsed. The warning or alert can also encourage the user to request a new subscription plan in order to obtain a new subscription plan key code. In some embodiments, the controller 24 can send a warning or alert to the user via the HMI of the system 10. In some embodiments, the controller 24 can send a warning or alert to the user via a wireless connection (e.g., via an internet connection) to an outside entity.

It will be appreciated that in some embodiments, the system 10 can continue to process personalized documents using any of the other modules 12, 14, 16, 18 that are not subject to the subscription plan.

The method 40 then returns to 42.

In some embodiments, when the system 10 is operating under stringent security requirements that, for example, limit or precludes any communication with another entity that is not part of the system 10, active remote monitoring of the system 10 may not be possible. Accordingly, periodic (e.g., two or three times a year) manual and/or physical verifications of the system 10 may be performed to ensure that the system 10 is operating under the guidelines of the subscription plan.

It will be appreciated that the embodiments described herein is not limited to a central issuance personalized document processing system but can also be used in what may be referred to as a desktop personalized document processing system. Such a desktop personalized document processing system would include at least a personalized document input and a personalized document output (which may be at opposite ends of the system or at the same end of the system), and one or more personalized document processing modules. The one or more personalized document processing modules can include, for example, a DOD personalized document printing module that prints on the personalized documents using UV curable ink, and a UV cure station for curing the UV curable ink applied to the personalized document. Additional personalized document processing modules, such as those described above, may also be included. A desktop personalized document processing system is typically designed for relatively small scale, individual personalized document processing. In desktop processing systems, a single personalized document to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Corporation of Shakopee, Minn. Other examples of desktop card machines are disclosed in U.S. Pat. Nos. 7,434,728 and 7,398,972, each of which is incorporated herein by reference in its entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of operating a personalized document processing system under a subscription plan, wherein the personalized document processing system is configured to process a plurality of personalized documents, the method comprising:
a controller of the personalized document processing system receiving a subscription plan key code;
the controller verifying the subscription plan key code;
determining and setting a subscription threshold for a processing module of the personalized document processing system based on the subscription plan key code, wherein the processing module is configured to perform a processing operation on one or more of the plurality of personalized documents;
tracking operation of the processing module to determine whether the subscription threshold has been reached; and
adjusting operation of the processing module when the subscription threshold has been reached.

2. The method of claim 1, wherein the personalized document processing system is a card processing system.

3. The method of claim 1, wherein the personalized document processing system is a passport processing system.

4. A personalized document processing system for processing a plurality of personalized documents, comprising:
a processing module configured to perform a processing operation on one or more of the plurality of personalized documents; and
a controller configured to control operation of the processing module, wherein the controller is also configured to:
receive a subscription plan key code,
verify the subscription plan key code,
determine and set a subscription threshold for the processing module based on the subscription plan key code,
track operation of the processing module to determine whether the subscription threshold has been reached, and
adjust operation of the processing module when the subscription threshold has been reached.

5. The personalized document processing system of claim 4, wherein the personalized document processing system is a card processing system.

6. The personalized document processing system of claim 4, wherein the personalized document processing system is a passport processing system.

7. A method of updating a subscription plan on a secured personalized document processing system, the method comprising:
loading a subscription plan key code onto a memory device that is separate from the secured personalized document processing system;
physically connecting the memory device to the secured personalized document processing system;
transferring the subscription plan key code from the memory device to a controller of the secured personalized document processing system;
the controller receiving the subscription plan key code; and
the controller adjusting operation of a processing module of the secured personalized document processing system based on the subscription plan key code.

8. The method of claim 7, wherein the secured personalized document processing system is a secured card processing system.

9. The method of claim 7, wherein the secured personalized document processing system is a secured passport processing system.

10. A method of updating a subscription plan on a secured personalized document processing system, the method comprising:
receiving a manual entry of a subscription plan key code via a human machine interface of the secured personalized document processing system;
transferring the subscription key code in a controller of the secured personalized document processing system;
the controller receiving the subscription plan key code; and
the controller adjusting operation of a processing module of the secured personalized document processing system based on the subscription plan key code.

11. The method of claim 10, wherein the secured personalized document processing system is a secured card processing system.

12. The method of claim 10, wherein the secured personalized document processing system is a secured passport processing system.
